(19) United States
(12) Patent Application Publication
(10) Pub. No.: US 2006/0025914 A1
(43) Pub. Date: Feb. 2, 2006

(54) Construction machine and control panel

(75) Inventor: Martin Buschmann, Neustadt (DE)

Correspondence Address: DARBY & DARBY P.C., P. O. BOX 5257, NEW YORK, NY, 10150-5257, US

(73) Assignee: Joseph Vogele AG, Mannheim (DE)

(21) Appl. No.: 11/191,383

(22) Filed: Jul. 27, 2005

(30) Foreign Application Priority Data
Jul. 27, 2004 (EP) 04 017 762.8

(51) Int. Cl. G06F 19/00

(52) U.S. Cl. 701/50; 701/1

(57) ABSTRACT

A control panel K for the control device of a construction machine, particularly of a road paver or a feeder, comprises in an operation console housing 1, 1′ at least one group consisting of different electronic command signalling devices 5 to 11 which are separated among replaceably provided logic service units E1 to E8.

The invention relates to a construction machine of a type according to the preamble of claim 1 and to a control panel according to the preamble of claim 14.

It is known to provide command signalling devices like switches or the like for the control panel of a construction machine, particularly for a road paver or a feeder, either as single line wiring or as a monolithic keyboard, e.g. a foil keyboard, respectively. Single line wiring has the advantage of allowing the replacement of single command signalling devices in case of damage. However, single line wiring by nature needs intensive and costly mounting effort and takes a long time to manufacture. Monolithic foil keyboards and other print board compatible monolithic concepts can be manufactured with significantly less cost. However, in case of damage to the command signalling device a complete replacement is needed, finally resulting in high costs for such service cases.

It is an object of the invention to provide a construction machine with a control panel which can be manufactured for fair costs and which allows fair cost service cases. A part of the object is to maintain full operability in case of a breakdown of at least certain command signalling devices in order to increase the availability of the construction machine.

With a view to low manufacturing costs command signalling devices are used in the control panel of the construction machine which are compatible with printed circuit boards. However, the command signalling devices are not incorporated into the control panel in a monolithic fashion but are distributed on smaller logic service units in order to reduce the costs for service cases. The service units are formed such that they can be replaced individually. Due to their reduced complexity these service units can be replaced in a service case for fair costs. Furthermore, the concept allows the provision of an at least low end redundancy between the services units. The availability of the construction machine is increased, because a function which has broken down in case of a breakdown of a command signalling device or even in case of a breakdown of a service unit can be provided by at least another command signalling device or another service unit, respectively.

Expediently, each service unit comprises several command signalling devices the number and combination of which may be selected with a view to ergonomic handling comfort and/or to the frequency of occurrences of breakdowns according to experience.

In a preferred embodiment the command signalling devices of a service unit are combined such that they form a grouping which is ergonomically and functionally logical. This may e.g. mean that command signalling devices are combined which belong to functions of certain sequences of operations.

In another preferred embodiment at least two such control panels are included in a main operator's platform and in at least one external operator's control area of the same construction machine. The respective external operator's control area is equipped with at least one command signalling device in at least one service unit which command signalling device is functionally on a par with one command signalling device of a service unit of the main operator's platform.

With a view to simple manufacturing and assembly the command signalling devices of a service unit are connected to at least one printed circuit board which is incorporated into the service unit.

In order to allow the replacement of a service unit in a service case even by laypersons, it is expedient to provide the service unit with connectors which are protected against reversed polarity (reversed polarity safe connectors). Furthermore, it is expedient to connect each service unit detachably with the control panel housing, preferably by screwing, in order to allow a comfortable replacement.

With a view to increased availability of the construction machine it is important in an expedient embodiment that at least a major part, preferably all, of the functions which are present provided by the command signalling devices in one service unit is or are provided at least a second time within the entirety of all other service units. This results in an at least low-end redundancy among the service units and assures that a breakdown of a command signalling device or even a breakdown of a service unit does not adversely affect the availability of the construction machine. A broken down function or even the functions of an entire broken down service unit remains available upon demand by other common signal devices or services unit. For example, the given functions are provided at least a second time in the same and/or in a further control panel casing or in the form of software to be activated upon demand via other command signalling devices or service units, respectively. Furthermore, it is possible to retrievably provide the given functions at least a second time available via a display which may be incorporated into one service unit. In this case the command signalling device or the service unit which has broken down is deviated by using the display such that the command signalling device or the service unit comfortably first needs to be replaced at a convenient point in time, e.g. at the end of the work. Although the control panel housing protects and shields the single service units during operation, it may be expedient to incorporate each service unit into an encapsulation shell. This also may be expedient to prevent undesirable manipulations in case of repair attempts.

In order to ensure the correct replacement of service units even by laypersons in a simple and safe way, it is expedient that the different service units intended at least for the same control panel housing have different contour configurations such that each service unit only fits in a correspondingly shaped opening of the control panel housing.

Embodiments of the invention will be explained with the help of the drawing. In the drawing is:

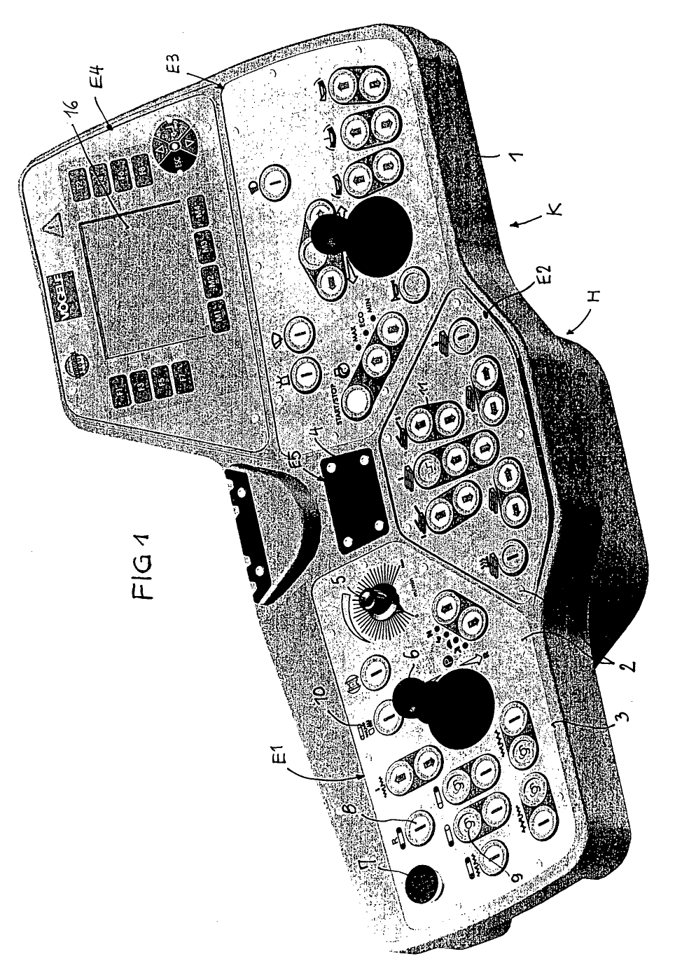

FIG. 1 a perspective top view of a control panel comprising several service units,

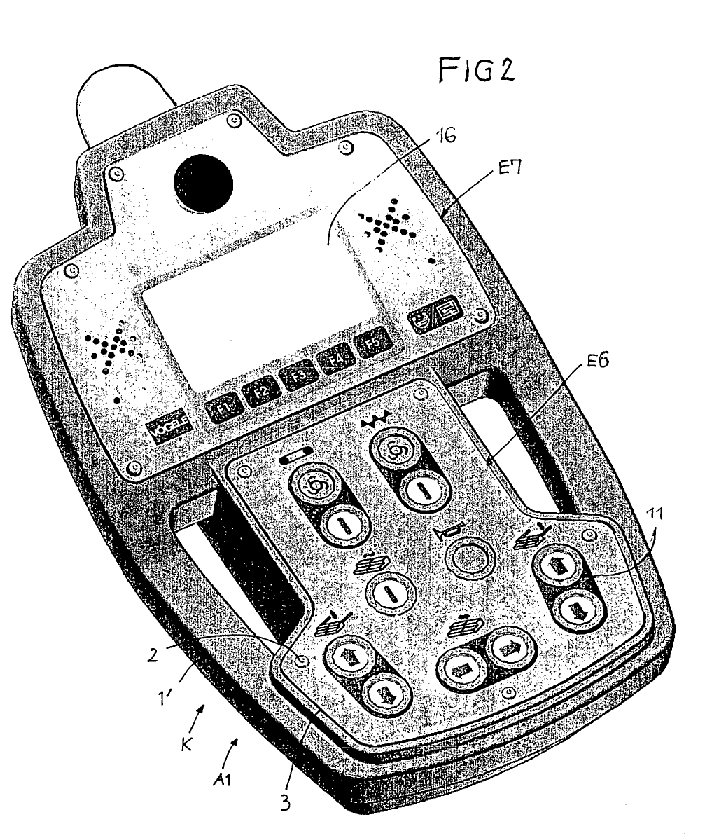

FIG. 2 a perspective view of another embodiment of a control panel comprising several service units,

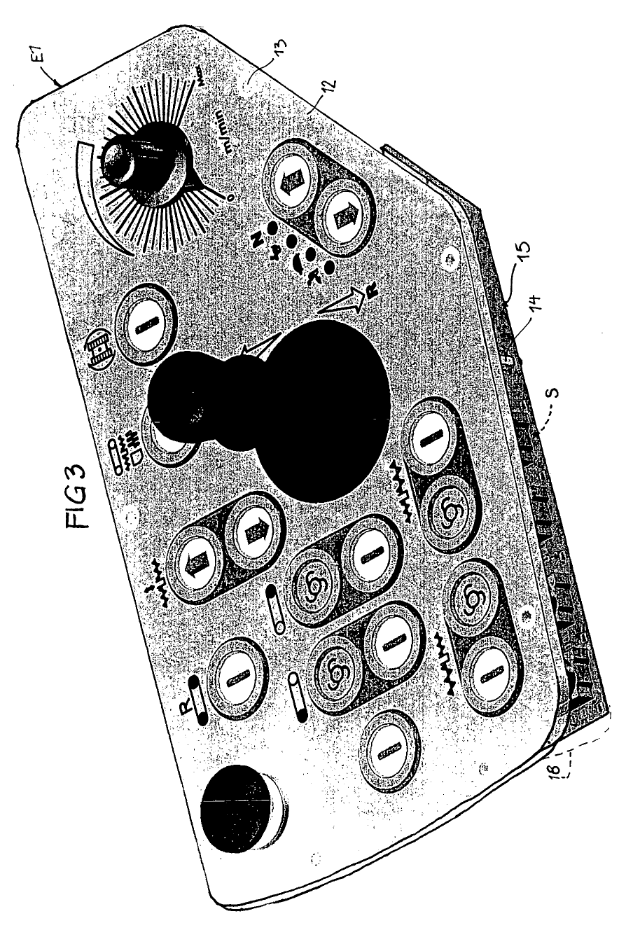

FIGS. 3-5 different kinds of service units of the control panel of FIG. 1,

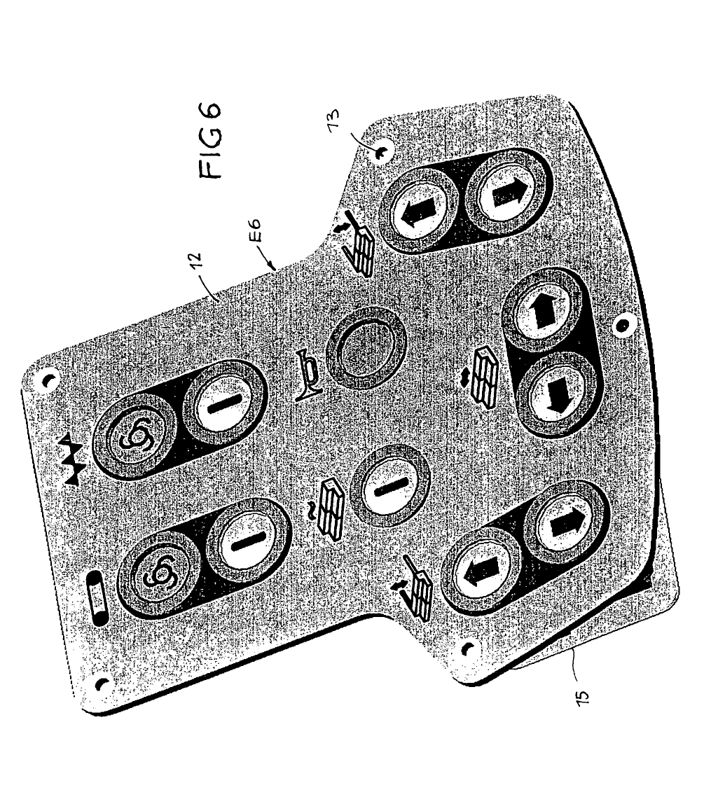

FIG. 6 a perspective illustration of a service unit of the control panel of FIG. 2,

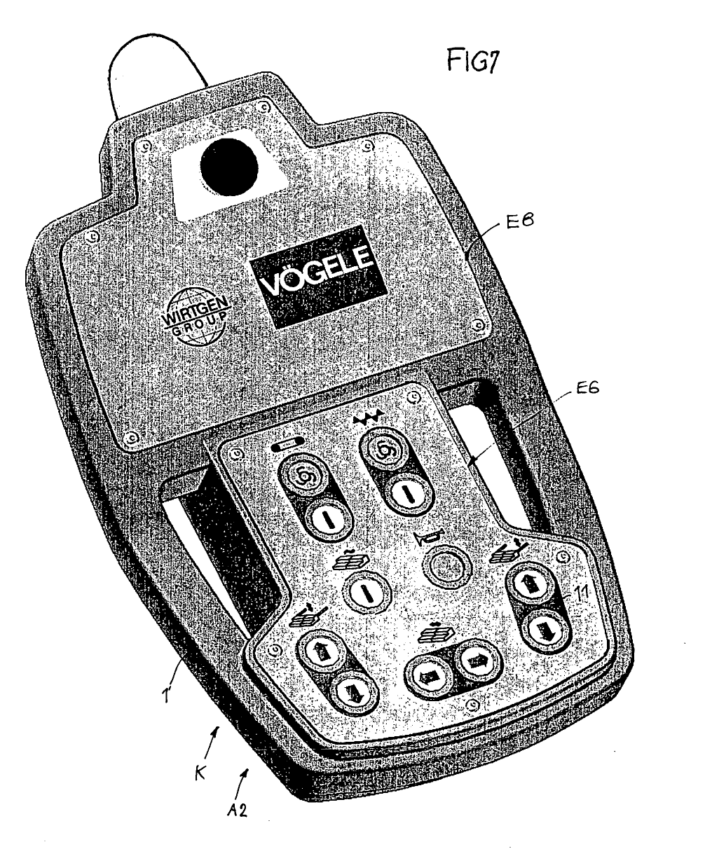

FIG. 7 a perspective view of a further embodiment of a control panel comprising several service units, and

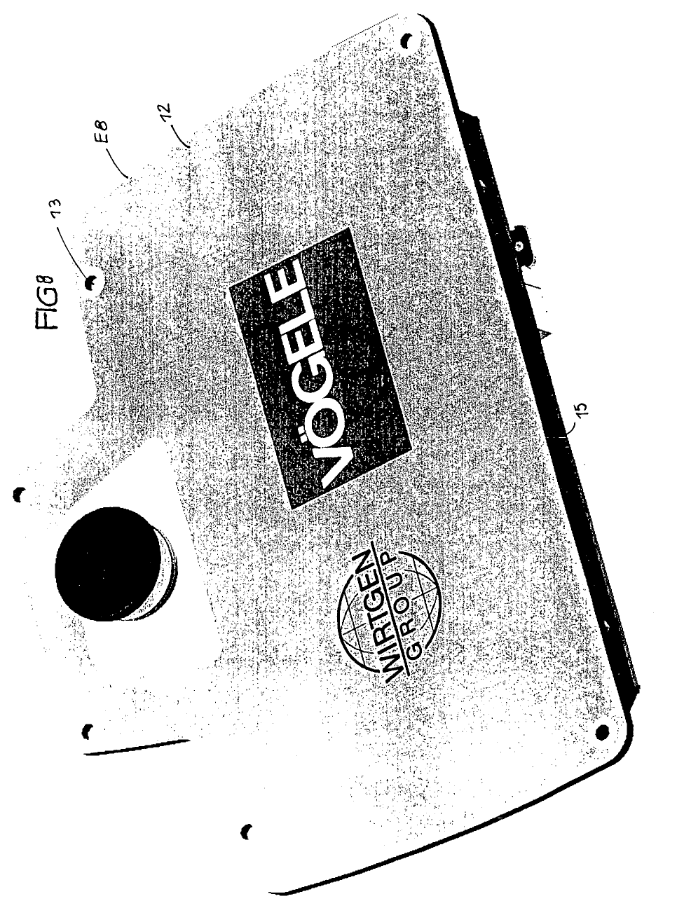

FIG. 8 a service unit of the control panel of FIG. 7.

A construction machine (not shown) like a road paver or feeder is equipped, as is conventional in this field, with a control device for several functional components in order to activate, control, regulate and/or monitor the functional components during the operating travel or during the transport travel. For this purpose at least one control panel K is provided at a suitable location in the construction machine. The control panel K contains several, preferably electronic, command signalling devices and, in some case, monitoring devices or recording devices. The control panel K is connected with the control device. A conventional equipment consists of a main operator's platform with one control panel at the operator's platform of the construction machine and at least one external operator's control area which, in some cases, is connected to the main operators platform and/or the control device and which is positioned at a convenient location, e.g. at the paving screed or close to the conveying device. In some cases the control panel of the external operator's control area is even detachable and portable. All functional components of the construction machine can be operated and/or monitored from the main operator's platform while the at least one external operator's control area usually allows to operate and/or monitor only selected functional components in most cases. For this reason at least one large group of electronic command signalling devices is provided in the control panel of the main operator's platform while a smaller group of command signalling devices is provided at the at least one external operator's control area, in most cases selected command signalling devices which also may be present for the same functions in the control panel of the main operator's platform.

The control panel K shown in FIG. 1 for the main operator's platform H comprises a shell-shaped operation console housing 1 having an upper side with several cut-outs 3 which have different contours among themselves. In the cut-outs 3 service units E1, E2, E3, E4 having corresponding differing contour configurations are inserted in fitting fashion and e.g. secured by fastening screws 2. Furthermore, one cut-out 4 can be provided as a vacant cut-out for a further service unit E5 and may be closed with a blind.

Each service unit E1 to E4 is logically and ergonomically structured with a group of electronic command signalling devices representing certain functions for controlling and/or monitoring of working components of the construction machine. In the service unit E1 e.g. the command signalling device 5 is a rotary switch 9 and an operation indicator having a press button. Symbolic images 10 are associated to the command signalling devices indicating the respective operation function of the construction machine. Another grouping of command signalling devices is provided in the service unit E2, e.g. a dual press switch 11 for a lifting motion of a linking point of a right-side tow bar of the paving screed. Other command signalling devices in a different grouping are combined in the service unit E3. Finally, a display 16 with keys and a directional keyboard are combined in the service unit E4.

The control panel K illustrated in FIG. 2 is intended for a so-called external operators control area A1 which may be provided in fixed or in removable fashion at a suitable location on an external side of the construction machine. In the operation console housing 1′ a service unit E6 in contained in a cut-out which service unit E6 contains several command signalling devices, and among others also the command signalling device 11 which also is present in the service unit E2 in FIG. 1. The service unit E7 in FIG. 2 contains a display 16, a keyboard and an emergency switch off button. The service units E6, E7 are removably secured in the operation console housing 1′ by screws 2.

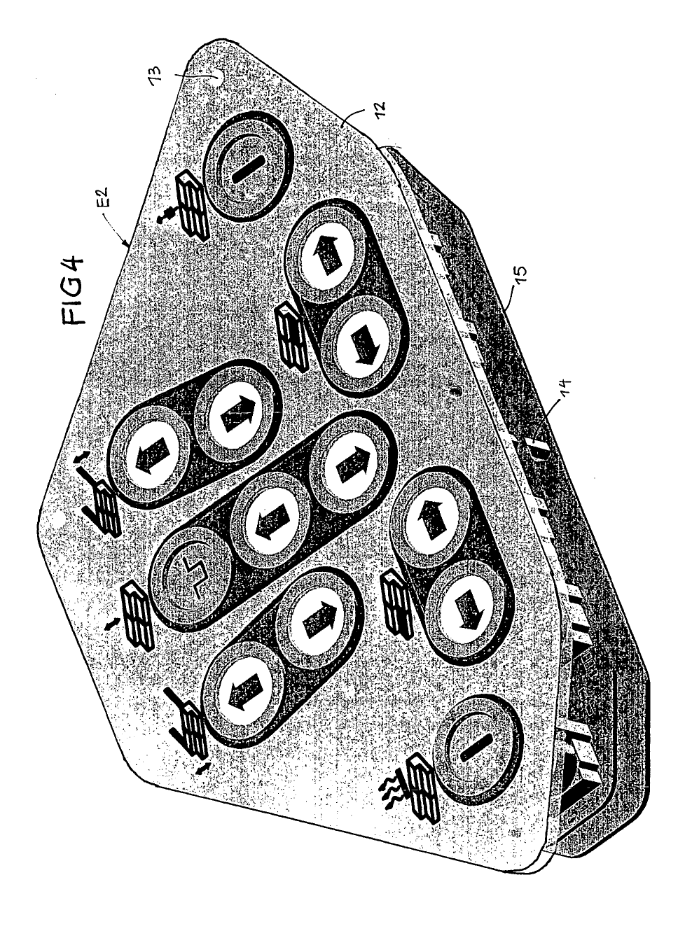

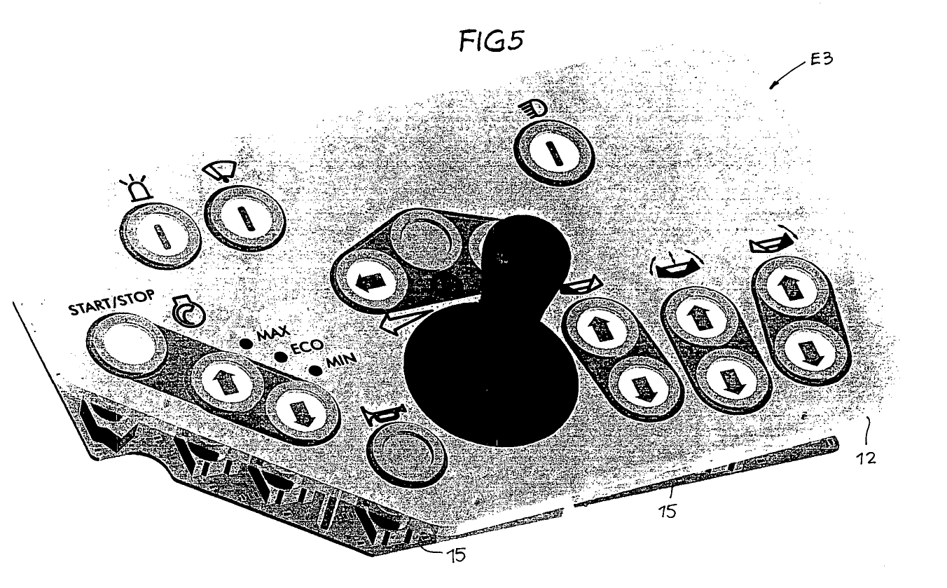

FIGS. 3, 4 and 5 illustrate the service units E1, E2 and E3 of the control panel K in FIG. 1. The command signalling devices, respectively, are arranged in a front plate 12 which determines by the cut-out shapes the contour configurations for the service units and contains holes 13 for the fastening screws 2. A printed circuit board 15 is functionally connected via spacer elements 14 to the electronic command signalling devices and the front plate 12. In some cases, the entire service unit, e.g. E1 in FIG. 3, may be contained in protected fashion in an encapsulating shell 18 from which at the lower side only connectors S protrude which are protected against reverse polarity (reverse polarity safe connectors) for the connection to counter connectors in the operation console housing 1, 1′. The same design is present in the service unit E2 and also in the service unit E3 (FIGS. 4 and 5). In FIG. 5 two printed circuit boards 15 are provided.

The service unit E6 in FIG. 6 serves for the assembly into the control panel K of FIG. 2 (and as well into the control panel K of FIG. 7), and has a front plate 12 which is designed in accordance with the contour of a certain cut-out 3 in the operation console housing 1′.

The control panel K shown in FIG. 7 as well is intended for an external operator's control area A2 provided with the mounted service unit E8 having an emergency off switch as a command signalling member instead of the service unit E7 as assembled in FIG. 2. The service unit E6 may correspond to the service unit E6 of FIG. 2, but has not necessarily to correspond with it.

FIG. 8 finally indicates the structure of the service unit E8 of the control panel K of FIG. 7 having the front plate 12 with the screw holes 13 and the printed circuit board 15. Expediently only electronic command signalling devices are used which are compatible with printed circuit boards in order to achieve fair production costs. The service units are small logic units. Logic means that command signalling devices for similar functions or for functions which commonly are needed for certain operation sequences are combined and arranged ergonomically at the service unit. Each service unit is individually replaceable. Due to the low level of complexity in comparison to a monolithic structure the service units are cheap such that service cases, i.e. a needed replacement, can be carried out for fair costs. A replacement even can be carried out by a layperson, because the service units are equipped with connectors which are protected against reverse polarity, because the service units only are fixed by threaded connections with the operation console housing, and since the contour configurations are selected such that mistakes like wrong service unit placement are prevented.

Within the entire concept an at least low end redundancy is provided among the service units. That means that a breakdown of a command signalling device of a service unit or even the breakdown of the service unit itself does not adversely affect the availability of the construction machine, because all functions which are represented by the command signalling devices of a service unit at least are present once more in the entirety of all other service units. For example, in case of a breakdown of a command signalling device in the main operator's platform the same function can be operated at the external operator's control area, or all functions are at least present a second time in the software and can be retrieved upon demand and can be operated from another service unit. For this purpose the display may be used at which a function can be retrieved which has broken down and which then e.g. is operated with the keyboard. The actual replacement of a service unit which has broken down totally or in part can be postponed for this reason to a suitable point in time without negatively affecting the availability of the construction machine.

1. A construction machine, comprising a control device and at least one control panel connected to the control device, the control panel containing at least one group of different command signalling devices in an operation console housing, the command signalling devices of the group being distributed in several separate logic service units said logic service units being replaceably arranged in the operation console housing, and each of the service units containing at least one command signalling device which is compatible with printed circuit boards.

2. Construction machine as in claim 1, wherein each service unit includes several command signalling devices.

3. Construction machine as in claim 2, wherein the command signalling devices within a service unit form an ergonomic and functional logical grouping.

4. Construction machine as in claim 1, wherein two control panels of the same construction machine are included in a main operator's platform and at least one external operator's control area, and that the respective external operator's control area comprises in at least one service unit at least one command signalling device which is functionally equivalent to at least one command signalling device in the service units of the main operator's platform.

5. Construction machine as in claim 1, wherein the command signalling devices of one service unit are connected with at least one printed circuit board incorporated into the service unit.

6. Construction machine as in claim 1, wherein each service unit comprises at least one connector which is protected against reverse polarity and a counter connector for said connector is positioned in the operation console housing.

7. Construction machine as in claim 1, wherein each service unit is detachably connected, with the operation console housing.

8. Construction machine as in claim 1 wherein at least a major part, of the functions present in a service unit by the provided command signalling devices is provided at least a second time within the entirety of all other service units.

9. Construction machine as in claim 8, wherein the functions present in said service unit are provided in at least a second control panel.

10. Construction machine as in claim 8, wherein the functions in said service unit are provided at least a second time in software.

11. Construction machine as in claim 8, wherein the functions present in said service unit are available by retrieval via a display which is incorporated into a service unit.

12. Construction machine as in claim 1, wherein each service unit comprises a encapsulating casing.

13. Construction machine as in claim 1 at least one of the preceding wherein the service units have differing contour configurations, and that differing cut-outs are formed in the operation console housing into which only a determined service unit fits.

14. Control panel for a construction machine, particularly for a road paver or a feeder, wherein the control panel is formed according to claim 1.
